(19) United States
(12) Patent Application Publication
(10) Pub. No.: US 2022/0212140 A1
(43) Pub. Date: Jul. 7, 2022

(54) HUMIDITY CONTROL DEVICE

(71) Applicant: SHARP KABUSHIKI KAISHA, Sakai City, Osaka (JP)

(72) Inventors: TETSUYA IDE, Sakai City, Osaka (JP); SHO OCHI, Sakai City, Osaka (JP); HIROKA HAMADA, Sakai City, Osaka (JP); TSUYOSHI KAMADA, Sakai City, Osaka (JP)

(73) Assignee: SHARP KABUSHIKI KAISHA, Sakai City, Osaka (JP)

(21) Appl. No.: 17/605,370

(22) PCT Filed: Apr. 16, 2020
(86) PCT No.: PCT/JP2020/016733

§ 371 Date: Oct. 21, 2021

(30) Foreign Application Priority Data
Apr. 23, 2019 (JP) 2019-082170

(51) Int. Cl. B01D 53/28; B01D 53/26; B01D 53/14; B01D 21/26; B01D 53/30; F24F 3/14

(52) U.S. Cl. CPC B01D 53/28; B01D 53/263; B01D 53/1425; B01D 53/1493; B01D 21/267; F24F 2003/1464; F24F 3/1417; B01D 2252/103; B01D 2252/2023; B01D 2252/504; B01D 53/30

(57) ABSTRACT

Provided is a humidity control device capable of stably absorbing and desorbing moisture. The humidity control device includes: a moisture absorber causing a hygroscopic material to come into contact with air so that the hygroscopic material absorbs portion of moisture contained in the air, the hygroscopic material being in liquid and containing water, polyalcohol having hygroscopicity, and metal salt having hygroscopicity; and a composition controller controlling composition of the hygroscopic material. The composition controller controls the composition of the hygroscopic material to be within a range in which the hygroscopic material is capable of absorbing the moisture while the metal salt is kept from being deposited.

### TECHNICAL FIELD

The present invention relates to a humidity control device. The present application claims priority to Japanese Patent Application No. 2019-082170, filed on Apr. 23, 2019, the contents of which are incorporated herein by reference in its entirety.

### BACKGROUND ART

Conventional humidity control devices known in the art adjust room humidity. A humidity control device disclosed in Patent Document 1 uses, for example, a liquid hygroscopic material to dehumidify a room.

The humidity control device cited in Patent Document 1 is capable of removing moisture absorbed into the hygroscopic material, such that the hygroscopic material is rendered reusable. The hygroscopic material cited in Patent Document 1 is a solution containing a solvent such as water and a hygroscopic substance dissolved in the solvent.

### CITATION LIST

### Patent Literature

Patent Document 1: WO 2018/235773

### SUMMARY OF INVENTION

### Technical Problem

The above humidity control device absorbs humidity with the hygroscopic material and removes water from the hygroscopic material to adjust humidity in a room environment. The humidity control device still has room for improvement in achieving stable humidity control performance.

In view of the above problem, an aspect of the present invention is intended to provide a humidity control device capable of stably absorbing and desorbing moisture.

### Solution to Problem

In order to solve the above problem, an aspect of the present invention provides a humidity control device including: a moisture absorber causing a hygroscopic material to come into contact with air so that the hygroscopic material absorbs portion of moisture contained in the air, the hygroscopic material being in liquid and containing water, polyalcohol having hygroscopicity, and metal salt having hygroscopicity; and a composition controller controlling composition of the hygroscopic material. The composition controller controls the composition of the hygroscopic material to be within a range in which the hygroscopic material is capable of absorbing the moisture while the metal salt is kept from being deposited.

In an aspect of the present invention, the composition controller may include: a measurer measuring a concentration of the hygroscopic material; an adjuster adjusting the concentration of the hygroscopic material; and a controller controlling an operation of the adjuster in accordance with a result of the measurement by the measurer.

In an aspect of the present invention, the adjuster may include an atomizing separator separating, from the hygroscopic material, portion of moisture contained in the hygroscopic material. The portion of the water may be separated in a form of atomized droplets.

In an aspect of the present invention, the atomizing separator may include an ejection outlet ejecting a mixture, containing the atomized droplets, out of the atomizing separator. The atomized droplets may include large droplets, and fine droplets smaller in diameter than the large droplets. The ejection outlet may be provided with a separator separating the large droplets from the mixture.

In an aspect of the present invention, the separator may be a cyclone separator.

In an aspect of the present invention, the adjuster may include a diluter adding water to the hygroscopic material.

In an aspect of the present invention, the polyalcohol may include glycerin.

In an aspect of the present invention, the metal salt may include lithium chloride.

In an aspect of the present invention, the metal salt may include calcium chloride.

### Advantageous Effects of Invention

The present invention can provide a humidity control device capable of stably absorbing and desorbing moisture.

### BRIEF DESCRIPTION OF DRAWINGS

FIG. 1 is a schematic diagram illustrating a humidity control device 1.

FIG. 2 is a phase diagram illustrating a hygroscopic material of a three-component system, the hygroscopic substance containing water, hygroscopic polyalcohol, and hygroscopic metal salt.

FIG. 3 is a block diagram illustrating a controller 60.

### DESCRIPTION OF EMBODIMENT

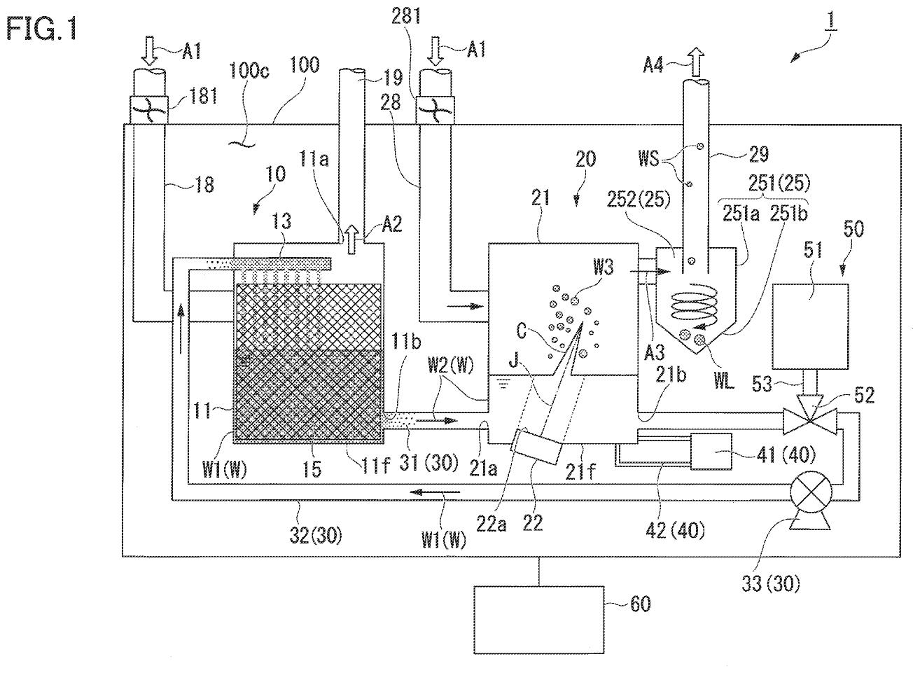

Described below is a humidity control device 1 according to this embodiment, with reference to FIGS. 1 to 3. Note that, in all the drawings below, the constituent features are illustrated in different dimensions and proportions as appropriate in view of viewability of the drawings.

FIG. 1 is a schematic diagram illustrating the humidity control device 1. In the drawings below, some constituent features can be illustrated in different scales of dimension in view of viewability of these constituent features.

### Humidity Control Device

As illustrated in FIG. 1, the humidity control device 1 according to this embodiment includes: a moisture absorber 10; an atomizing separator 20; a circulator 30; a measurer 40; a diluter 50; and a controller 60. The humidity control device 1 of this embodiment includes a casing 100. The moisture absorber 10, the atomizing separator 20, the circulator 30, the measurer 40, and the diluter 50 are housed in an internal space 100c of the casing 100.

The atomizing separator 20, the measurer 40, the diluter 50, and the controller 60 correspond to a “composition controller” of the present invention. Moreover, the atomizing separator 20 corresponds to an “adjuster” of the present invention.

### Moisture Absorber

The moisture absorber 10 includes: a first reservoir 11; a nozzle 13; a porous member 15; an intake passage 18; and an ejection passage 19.

The moisture absorber 10 causes a hygroscopic material W, containing a hygroscopic substance, to come into contact with air A1 found in an external space so that the hygroscopic material W absorbs at least portion of moisture contained in the air A1. The moisture absorber 10 desirably causes the hygroscopic material W to absorb as much moisture as possible. However, the moisture absorber 10 may cause the hygroscopic material W to absorb at least portion of the moisture contained in the air A1.

### First Reservoir, Intake Passage, Ejection Passage

The first reservoir 11 reserves the hygroscopic material W. The hygroscopic material W will be described later.

The intake passage 18 and the ejection passage 19 are connected to the first reservoir 11. Moreover, pipes 31 and 32 are also connected to the first reservoir 11. The pipes 31 and 32 are included in the circulator 30 to be described later.

Along the intake passage 18, a blower 181 is provided. The blower 181 takes the air A1 from the external space of the casing 100, and sends the air A1 to the inside of the first reservoir 11 through the intake passage 18. Moreover, the blower 181 creates an air current to flow from the inside of the first reservoir 11 through the ejection passage 19 out of the casing 100.

The first reservoir 11 includes an ejection port 11b to which the pipe 31 is connected. Moreover, the pipe 32 is connected to the nozzle 13 to be described later. The first reservoir 11 is supplied with a hygroscopic material W1 from a second reservoir 21 through the pipe 32.

In the second reservoir 21, at least portion of moisture is removed from a hygroscopic material W2 utilizing a device configuration to be described later, so that the hygroscopic material W1 is generated. The generated hygroscopic material W1 is ejected from an ejection port 21b.

### Nozzle

The nozzle 13 is disposed in an upper portion of an internal space in the first reservoir 11. Through the pipe 32, the hygroscopic material W1 returns from the atomizing separator 20 to the moisture absorber 10. The hygroscopic material W1 then flows down from the nozzle 13 into the internal space of the first reservoir 11. When flowing down, the hygroscopic material W1 comes into contact with the air A1. This contact technique between the hygroscopic material W1 and the air A1 is commonly referred to as the “flow-down technique.”

Note that the hygroscopic material W1 and the air A1 may come into contact with each other not only with the flow-down technique, but also with any given technique. For example, the air A1 is foamed and supplied into the hygroscopic material W reserved in the first reservoir 11. Such a technique is referred to as the “bubbling” technique.

### Porous Member

The porous member 15 is formed into a rectangular plate having a mesh-like structure. The porous member 15 is provided approximately perpendicularly to a bottom plate 11f of the first reservoir 11.

At least one porous member 15 is provided inside the first reservoir 11. The porous member 15 preferably includes two or more porous members 15. The porous member 15 guides the hygroscopic material W, flowing out of the nozzle 13, toward the bottom plate 11f of the first reservoir 11. The hygroscopic material W flowing down from the nozzle 13 flows downward through the mesh of the porous member 15.

The air A1 found in the external space creates an air current flowing from the blower 181 toward an ejection port 11a of the first reservoir 11. The air current comes into contact with the hygroscopic material W flowing down from the nozzle 13 and the hygroscopic material W flowing down through the porous member 15.

Here, at least portion of the moisture contained in the air A1 is absorbed into the hygroscopic material W and removed from the air A1. That is, air A2 to be ejected from the ejection port 11a is drier than the air A1 in the external space.

The air A2 created in the moisture absorber 10 is ejected out of the casing 100 through the ejection passage 19.

### Hygroscopic Material

The hygroscopic material W is a liquid exhibiting a property to absorb moisture (hygroscopicity). After absorbing moisture, the hygroscopic material W shows a decrease in hygroscopicity. However, using the atomizing separator 20 to be described later, at least portion of the absorbed moisture can be removed from the hygroscopic material W. Such a feature makes it possible to render the hygroscopic material W reusable.

Preferably, the hygroscopic material W exhibits the hygroscopicity under such a condition as, for example, a temperature of 25° C. and a relative humidity of 50% at atmospheric pressure.

The hygroscopic material W of this embodiment contains water serving as a solvent, polyalcohol having hygroscopicity, and metal salt having hygroscopicity. The hygroscopic polyalcohol and the hygroscopic metal salt are hygroscopic substances contained in the hygroscopic material W.

Examples of the polyalcohol include glycerin, propanediol, butanediol, pentanediol, trimethylolpropane, butanetriol, ethylene glycol, diethylene glycol, and triethylene glycol. Moreover, the polyalcohol may be a dimer or a polymer of polyalcohol. In particular, the polyalcohol preferably includes glycerin, diglycerin, and polyglycerin.

The polyalcohol to be used may be of either one kind alone, or two or more kinds combined.

Examples of the metal salt include calcium chloride, lithium chloride, magnesium chloride, potassium chloride, sodium chloride, zinc chloride, aluminium chloride, lithium bromide, calcium bromide, potassium bromide, sodium hydroxide, and sodium pyrrolidone carboxylate. In particular, the metal salt preferably includes lithium chloride and calcium chloride.

The metal salt to be used may be of either one kind alone or two or more kinds combined.

That is, the hygroscopic material W to be used in the humidity control device 1 is preferably: a hygroscopic material containing water, glycerin, and lithium chloride; a hygroscopic material containing water, glycerin, and calcium chloride; a hygroscopic material containing water, diglycerin, and lithium chloride; a hygroscopic material containing water, diglycerin, and calcium chloride; a hygroscopic material containing water, polyglycerin, and lithium chloride; or a hygroscopic material containing water, polyglycerin, and calcium chloride.

Other than the above materials, the hygroscopic material W may include an organic solvent having an amide group, sugars, and publicly known materials to be used as ingredients of, for example, moisturizing cosmetics.

Examples of the organic solvent having an amide group include formamide and acetamide.

Examples of the sugars include sucrose, pullulan, glucose, xylene, fructose, mannitol, and sorbitol.

Examples of the publicly known materials to be used as ingredients of moisturizing cosmetics include 2-methacryloyloxyethyl phosphorylcholine (MPC), betaine, hyaluronic acid, and collagen.

The hygroscopic material W has a viscosity of 25 mPa·s or below. Thanks to this viscosity, the atomizing separator 20 to be described later is easily create a plume C of the hygroscopic material W on the surface of the hygroscopic material W. Such a feature makes it possible to efficiently separate moisture from the hygroscopic material W.

The inventors have conducted studies to find out that, if polyalcohol alone is used as the hygroscopic substance to be dissolved into water in order to prepare the hygroscopic material W, the hygroscopicity of the hygroscopic material W increases as a concentration of the hygroscopic material W increases. However, the studies show that the atomizing separator 20 suffers a decrease in efficiency of removing moisture.

Moreover, if metal salt alone is used as the hygroscopic substance, the hygroscopic material W is high in hygroscopicity, and the hygroscopicity increases as a concentration of the hygroscopic material W increases. However, the studies show a drawback of the hygroscopic material W containing metal salt alone as the hygroscopic substance. When the atomizing separator 20 separates moisture from the hygroscopic material W, the separating moisture is likely to contain the metal salt.

Hence, the studies of the hygroscopic material W prepared in conventional manners show a trade-off between the hygroscopicity and the efficiency in separating moisture by atomization. Such a hygroscopic material W has required improvements.

In contrast, the hygroscopic material W to be used for the humidity control device 1 of the present application contains both polyalcohol and metal salt. Such a feature makes it possible to improve the efficiency in separating moisture by atomization and to enhance hygroscopicity, compared with a hygroscopic material containing either polyalcohol or metal salt alone as a hygroscopic substance.

The hygroscopic material W contains both polyalcohol and metal salt, such that the polyalcohol and the metal salt are believed to form a coordination complex. Hence, the metal salt dissolved into the hygroscopic material W is bound by the polyalcohol, and is less likely to move. Thanks to such a feature, the metal salt contained in the hygroscopic material W is less likely to mix with atomized droplets W3 generated by the atomizing separator 20 to be described later, making it possible to improve efficiency in separating water by atomization.

### Composition Controller

The atomizing separator 20 includes: the second reservoir 21; an ultrasonic transducer 22; a separator 25; an intake passage 28; and an ejection passage 29. The atomizing separator 20 atomizes at least portion of moisture contained in the hygroscopic material W2 supplied from the moisture absorber 10 through the pipe 31, and removes at least portion of the moisture from the hygroscopic material W2. Such a feature enhances the hygroscopicity of the hygroscopic material W2 again, so that the hygroscopic material W1 can be returned to the moisture absorber 10 and reused. The ejection passage 29 corresponds to an ejection outlet of the present invention.

### Second Reservoir, Intake Passage, Ejection Passage

The intake passage 28, the ejection passage 29, and the pipes 31 and 32 are connected to the second reservoir 21. Along the intake passage 28, a blower 281 is provided. The blower 281 supplies the air A1 to an internal space of the second reservoir 21 through the intake passage 28.

The blower 281 takes the air A1 from the external space of the casing 100 and sends the air A1 to the inside of the second reservoir 21 through the intake passage 28. Moreover, the blower 281 creates an air current to flow from the inside of the second reservoir 21 through the ejection passage 29 out of the casing 100.

The second reservoir 21 includes: a fill port 21a to which the pipe 31 is connected; and the ejection port 21b to which the pipe 31 is connected. The second reservoir 21 is supplied with the hygroscopic material W2 from the first reservoir 11 through the pipe 31.

In the second reservoir 21, at least portion of moisture is removed from the hygroscopic material W2 utilizing a device configuration to be described later, so that the hygroscopic material W1 is generated. The generated hygroscopic material W1 is ejected from the ejection port 21b.

### Ultrasonic Transducer

The ultrasonic transducer 22 is provided to a bottom plate 21f of the second reservoir 21, and emits an ultrasonic wave toward the surface of the hygroscopic material W2 reserved in the second reservoir 21.

When emitting the ultrasonic wave to the hygroscopic material W2, the ultrasonic transducer 22 adjusts a condition for generating the ultrasonic wave so that the plume C of the hygroscopic material W2 can be formed on the surface of the hygroscopic material W2. From the plume C of the hygroscopic material W2, at least portion of moisture contained in the hygroscopic material W2 is atomized and separated. Hence, many atomized droplets W3 are produced.

Here, the “atomized droplets” are a group of fine airborne water droplets in the second reservoir 21. The atomized droplets W3 include large droplets WL, and fine droplets WS smaller in diameter than the large droplets WL.

The ultrasonic transducer 22 is provided at an angle to the bottom plate 21f of the second reservoir 21. Here, a radiation axis J is defined as an axis of the ultrasonic wave. The radiation axis J extends orthogonally from a center of an ultrasonic wave emission face 22a of the ultrasonic transducer 22.

The ultrasonic transducer 22 is angled with respect to the bottom plate 21f of the second reservoir 21. Hence, the ultrasonic wave is propagated from the ultrasonic wave emission face 22a toward the surface of the hygroscopic material W2 so that the radiation axis J is angled with respect to the surface of the hygroscopic material W2. Portion of the ultrasonic wave reaching the surface of the hygroscopic material W2 is reflected regularly on the surface. Here, an incident angle of the ultrasonic wave with respect to the surface of the hygroscopic material W2; that is, an angle between the surface and the radiation axis J, is not a right angle. That is why the ultrasonic wave reflected on the surface is less likely to return to the ultrasonic transducer 22. Hence, the ultrasonic transducer 22 is less likely to suffer damage by the ultrasonic wave emitted from the ultrasonic transducer 22 itself.

Moreover, since the radiation axis J is angled, the plume C is formed to be angled with respect to the surface of the hygroscopic material W2. That is, the ultrasonic transducer 22 is provided to the bottom plate 21f of the second reservoir 21, so that the plume C to be formed is angled with respect to the surface of the hygroscopic material W2.

The ultrasonic transducer 22 is angled so that an end, of the ultrasonic wave emission face 22a, toward the fill port 21a is positioned high, and another end, of the ultrasonic wave emission face 22a, toward the ejection port 21b is positioned low. That is, the ultrasonic transducer 22 is provided such that the plume C, to be formed on the surface of the hygroscopic material W2, is angled toward the ejection port 21b.

The ultrasonic transducer 22 is preferably angled in a direction as described above so that the plume C is less likely to be deformed, compared with the case where the ultrasonic transducer 22 is angled against the above direction.

A mixture A3, which contains the atomized droplets W3 generated from the plume C, is released from the ejection passage 29 out of the second reservoir 21.

In order to confirm advantageous effects of a combined use of polyalcohol and metal salt as the hygroscopic material W, hygroscopic materials (1) to (3) were prepared. After the hygroscopic materials (1) to (3) had absorbed moisture, a device model having the same configuration as the atomizing separator 20 had was operated to check how moisture was separated from the hygroscopic materials (1) to (3) by atomization:

(1) a glycerin aqueous solution at 80 mass percent;

(2) a lithium chloride aqueous solution exhibiting the same hygroscopicity as the aqueous solution (1) did; and

(3) an aqueous solution of lithium chloride and glycerin exhibiting the same hygroscopicity as the aqueous solution (1) did.

In order to control concentrations of the aqueous solutions (2) and (3), a three-phase diagram of lithium chloride, glycerin, and water was used to identify composition, of the aqueous solutions (2) and (3), that expresses the hygroscopicity equivalent to the hygroscopicity of the aqueous solution (1). Moreover, viscosities of the aqueous solutions were higher in the order of (1), (3), and (2). As to the viscosity, the aqueous solution (1) was the highest and the aqueous solution (2) was the lowest.

The measurement result showed that the aqueous solution (3) was higher in efficiency of separating moisture by atomization (a rate of an amount of separated water to supplied electric power) than the aqueous solution (1). Moreover, the measurement confirmed that the moisture separated from the aqueous solution (3) did not contain lithium chloride, and the aqueous solution (3) allowed moisture to be separated more precisely than the aqueous solution (2) did.

Furthermore, similar to the hygroscopic materials (1) to (3), hygroscopic materials (4) to (9) were prepared. After the hygroscopic materials (4) to (9) had absorbed moisture, a device model having the same configuration as the atomizing separator 20 had was operated to check how moisture was separated from the hygroscopic materials (4) to (9) by atomization:

(4) an aqueous solution of lithium chloride and glycerin exhibiting the same hygroscopicity as the aqueous solution (3) did;

(5) an aqueous solution of lithium chloride and diglycerin exhibiting the same hygroscopicity as the aqueous solution (3) did;

(6) an aqueous solution of lithium chloride and polyglycerin (polyglycerin #300) exhibiting the same hygroscopicity as the aqueous solution (3) did;

(7) an aqueous solution of lithium chloride and polyglycerin (polyglycerin #300) exhibiting the same hygroscopicity as the aqueous solution (3) did;

(8) an aqueous solution of lithium chloride and polyglycerin (polyglycerin #500) exhibiting the same hygroscopicity as the aqueous solution (3) did; and

(9) an aqueous solution of lithium chloride and polyglycerin (polyglycerin #500) exhibiting the same hygroscopicity as the aqueous solution (3) did.

Note that, the hygroscopic materials (4), (6), and (8) were the hygroscopic material (3) with glycerin replaced with diglycerin or polyglycerin, and a percentage of the water decreased. Hence, the hygroscopic materials (4), (6), and (8) were prepared to exhibit the same hygroscopicity as the hygroscopic material (3) did. Furthermore, the hygroscopic materials (5), (7), and (9) were the hygroscopic material (3) with the glycerin replaced with diglycerin or polyglycerin, and a percentage of the lithium chloride increased. Hence, the hygroscopic materials (5), (7), and (9) were prepared to exhibit the same hygroscopicity as the hygroscopic material (3) did.

When the efficiency of separating moisture from the aqueous solution (3) by atomization (a ratio of the amount of separated moisture with respect to supplied electric power) is denoted as 1, the measurement results below showed relative values of the efficiency in separating moisture from the aqueous solutions (4) to (9) by atomization.

Efficiency in separating moisture from the aqueous solution (4) by atomization: 1.18

Efficiency in separating moisture from the aqueous solution (5) by atomization: 1.10

Efficiency in separating moisture from the aqueous solution (6) by atomization: 1.20

Efficiency in separating moisture from the aqueous solution (7) by atomization: 1.28

Efficiency in separating moisture from the aqueous solution (8) by atomization: 1.32

Efficiency in separating moisture from the aqueous solution (9) by atomization: 1.18

As can be seen, the obtained relative values confirmed that the aqueous solutions (4) to (9) allowed moisture to be separated more precisely than the aqueous solution (3) did.

### Separator

A separator 25 is provided in a path of the ejection passage 29. The separator 25 of this embodiment is referred to as a cyclone separator.

The separator 25 includes: a separation tank 251; and a guide pipe 252.

The separation tank 251 includes: a cylinder 251a; and a cone 251b connected to a lower portion of the cylinder 251a and communicating with the cylinder 251a. The cylinder 251a has an upper portion closed with a top. The cone 251b protrudes downward.

The guide pipe 252 penetrates the top of the cylinder 251a to be inserted in the cylinder 251a.

The ejection passage 29 is connected to a side face of the cylinder 251a and the guide pipe 252.

The separator 25 creates a downward spiral flow of the mixture A3 inside the separation tank 251, and separates the atomized droplets W3 contained in the mixture A3 into the fine droplets WS and the large droplets WL.

The separated fine droplets WS are transported to the guide pipe 252 by an air current flowing from the cone 251b toward the cylinder 251a of the separation tank 251. The fine droplets WS are released out of the casing 100 through the ejection passage 29 connected to the guide pipe 252.

Air A4, obtained by the separator 25, contains the separated fine droplets WS, and thus is wetter than the air (the air A1) outside the casing 100.

Meanwhile, the large droplets WL cannot move with the air current flowing from the cone 251b toward the cylinder 251a, and fall down to the bottom of the cone 251b. The large droplets WL falling down to the cone 251b may return to the second reservoir 21 through a not-shown pipe.

### Circulator

A circulator 30 circulates the hygroscopic material W between the moisture absorber 10 and the atomizing separator 20.

The circulator 30 includes the pipes 31 and 32 connected to the moisture absorber 10 and the atomizing separator 20, and forming a circular passage of the hygroscopic material W. Moreover, the circular 30 includes a pump 33 provided in a path of the pipe 32.

From the moisture absorber 10 to the atomizing separator 20, the pipe 31 transports the hygroscopic material W2 absorbing at least portion of the moisture. The pipe 31 has an end connected to the ejection port 11b provided below the surface of the hygroscopic material W1 in the first reservoir 11.

Meanwhile, the pipe 31 has another end connected to the fill port 21a provided below the surface of the hygroscopic material W2 in the second reservoir 21.

From the atomizing separator 20 to the moisture absorber 10, the pipe 32 transports the hygroscopic material W1 whose moisture is removed (the hygroscopic material W). The pipe 32 has an end connected to the ejection port 21b provided below the surface of the hygroscopic material W2 in the second reservoir 21.

Meanwhile, the pipe 32 has another end connected to the nozzle 13 provided above the surface of the hygroscopic material W1 in the first reservoir 11.

The pump 33 is provided in the path of the pipe 32 to render the hygroscopic material W flow. The pump 33 may be provided also to the pipe 31. Furthermore, a pump may be provided to each of the pipes 31 and 32 to independently control a flow of the hygroscopic material W from the moisture absorber 10 to the atomizing separator 20 and a flow of the hygroscopic material W from the atomizing separator 20 to the moisture absorber 10.

### Measurer

The measurer 40 is provided to the second reservoir 21 to measure a concentration of the hygroscopic material W2 in the second reservoir 21. The measurer 40 includes: a sensor 41; and a pipe 42 connected to the sensor 41. In the measurer 40, portion of the hygroscopic material W2 in the second reservoir 21 is supplied to the sensor 41 through the pipe 42. The sensor 41 measures the concentration of the hygroscopic material W2.

Here, the concentration of the hygroscopic material W2 to be measured by the sensor 41 is a percentage of all the substances (a sum of the polyalcohol and the metal salt) dissolved and contained in the hygroscopic material W2. Moreover, the sensor 41 may measure percentages of the polyalcohol and the metal salt contained in the hygroscopic material W2.

In such a case, an electric conductivity may be previously measured for each of hygroscopic materials containing polyalcohol and metal salt at different percentages. The electric conductivities may be used as numerical values corresponding to the concentrations of the polyalcohol and the metal salt. For example, a table can be prepared to indicate corresponding relationships between the proportions of the composition of the hygroscopic material W2 and the electric conductivities of the hygroscopic material W2, so that the table may be used as reference data for controlling the composition of the hygroscopic material W2. In this case, the sensor 41 measures an electric conductivity of the hygroscopic material W2, so that, on the basis of the obtained electric conductivity, the percentages of the polyalcohol and the metal salt contained in the hygroscopic material W2 can be controlled with reference to the table.

The sensor 41 may have any given configuration as long as the sensor 41 can measure a concentration of the hygroscopic material W2. For example, the sensor 41 may be a sensor to measure a refractive index of the hygroscopic material W2 and to obtain the concentration of the hygroscopic material W2 in accordance with the obtained refractive index. In such a case, refractive indexes may be previously measured of multiple samples having different proportions and concentrations of the substances dissolved in the hygroscopic material W2, and corresponding relationships may be previously prepared between the reflective indexes and the concentrations of the hygroscopic materials W2.

### Diluter

The diluter 50 includes: a water storage tank 51; a connector 52; and a pipe 53 connecting the water storage tank 51 and the connector 52 together.

The water storage tank 51 stores water for adjusting the composition of the hygroscopic material W.

The connector 52 may be, for example, a three-way solenoid valve to be opened and closed by the controller 60.

The diluter 50 is connected to the pipe 32. The diluter 50 adds water to, and dilutes, the hygroscopic material W2 flowing in the pipe 32.

### Controller

The controller 60 controls an operation of the humidity control device 1.

As can be seen, the hygroscopic material W to be used for the humidity control device 1 is of a three-component system. The hygroscopic material W contains water, hygroscopic polyalcohol, and hygroscopic salt. If, for example, the percentage of the water content is low in the composition of the hygroscopic material W, the metal salt might be deposited on, and clog, the nozzle 13 and the circulator 30. Moreover, if the percentage of the hygroscopic substance content is low in the composition of the hygroscopic material W, the hygroscopic material W might not absorb moisture, and could fail to dehumidify the air.

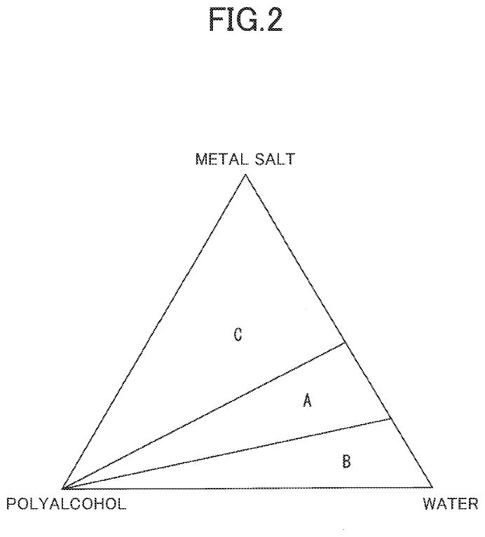

FIG. 2 is a phase diagram illustrating a hygroscopic material of a three-component system. The hygroscopic material contains water, hygroscopic polyalcohol, and hygroscopic metal salt. The phase diagram schematically illustrates the composition and the physical properties of the hygroscopic material.

The hygroscopic material whose composition is represented in a region A illustrated in FIG. 2 can exhibit excellent hygroscopicity and excellent separation of moisture in the atomizing separator 20. Meanwhile, the hygroscopic material whose composition is represented in a region B contains excessive water and cannot absorb moisture. Moreover, the hygroscopic material whose composition is represented in a region C inevitably causes deposition of the metal salt.

Meanwhile, the humidity control device 1 alternately absorbs moisture using the hygroscopic material W and removes moisture contained in the hygroscopic material W. Hence, the humidity control device 1 controls the composition of the hygroscopic material W to be within the region A of the phase diagram in FIG. 2, making it possible to stably absorb and desorb moisture.

The controller 60 included in the humidity control device 1 of this embodiment controls the constituent features as described below in order to control the concentration of the hygroscopic material W to be within a range represented with the region A in FIG. 2. Such control keeps from deposition of the metal salt while maintaining the physical properties of the hygroscopic material W to allow for absorption of moisture.

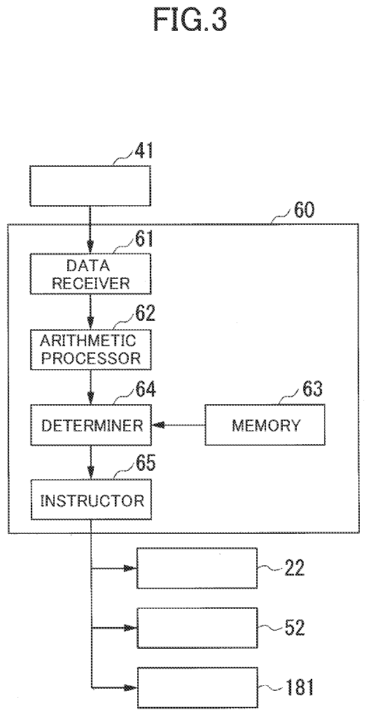

FIG. 3 is a block diagram illustrating the controller 60. As illustrated in FIG. 3, the controller 60 includes: a data receiver 61; an arithmetic processor 62; a memory 63; a determiner 64; and an instructor 65.

The data receiver 61 receives a result detected by the sensor 41. For example, if the sensor 41 is a refractometer, the data receiver 61 receives, as the detection result, data on a refractive index of the hygroscopic material W2 to be measured by the sensor 41.

The arithmetic processor 62 calculates a concentration of the hygroscopic material W2 in accordance with the detection result received from the data receiver 61.

The memory 63 stores a threshold corresponding to an upper limit of the concentration of the hygroscopic material W in an allowable range. Hereinafter, the threshold is referred to as an upper limit threshold.

Moreover, the memory 63 stores a threshold corresponding to a lower limit of the concentration of the hygroscopic material W in an allowable range. Hereinafter, the threshold is referred to as a lower limit threshold.

Note that the “threshold corresponding” to the upper limit in the allowable range may be the upper limit per se, or a value smaller than the upper limit. For example, if the threshold is set as the upper limit per se, the hygroscopic material W might further condenses while the concentration of the hygroscopic material W is controlled as described below. The condensation could start deposition of the metal salt contained in the hygroscopic material W. Hence, the threshold can be set smaller than the above upper limit not to start the deposition of the metal salt even if a time period required for adjustment of the concentration elapses.

Likewise, the “threshold corresponding” to the lower limit in the allowable range may be the lower limit per se, or a value larger than the lower limit. For example, if the threshold is set as the lower limit per se, the hygroscopic material W might further be diluted while the concentration of the hygroscopic material W is controlled as described below. Consequently, the concentration of the hygroscopic material W might fall so low that the hygroscopic material W could not absorb moisture in the moisture absorber 10. Hence, the threshold can be set larger than the above lower limit so that the hygroscopic material W can absorb moisture in the moisture absorber 10 during adjustment of the concentration of the hygroscopic material W.

In accordance with the concentration of the hygroscopic material W2 obtained by the arithmetic processor 62 and the threshold of the concentration of the hygroscopic material W stored in the memory 63, the determiner 64 determines whether the concentration of the current hygroscopic material W2 is within a range in which the hygroscopic material W is capable of absorbing moisture while the metal salt is kept from being deposited.

In accordance with the result of the determination by the determiner 64, the instructor 65 instructs the atomizing separator or the diluter to control the concentration of the hygroscopic material W.

Specifically, if the concentration of the hygroscopic material W is higher than the threshold corresponding to the upper limit in the allowable range, the instructor 65 instructs the connector 52 connecting to the water storage tank 51 to open so that hygroscopic material W2 flowing in the pipe 32 is diluted.

If the concentration of the hygroscopic material W is lower than the threshold corresponding to the lower limit in the allowable range, the instructor 65 instructs the ultrasonic transducer 22 to drive, so that moisture is separated from the hygroscopic material W in the atomizing separator 20. Here, the instructor 65 may stop the blower 181 to suspend absorption of moisture in the moisture absorber 10.

Furthermore, the instructor 65 finishes the above control of the concentration under a previously set condition.

In diluting the hygroscopic material W2, the instructor 65 may, for example, instruct the connector 52 connecting to the water storage tank 51 to close after a designated amount of water has been supplied from the water storage tank 51 to the interior of the pipe 42.

In separating moisture from, and condensing, the hygroscopic material W2, the instructor 65 may drive the ultrasonic transducer 22 for a certain time period, and then suspend the ultrasonic transducer 22.

Moreover, the instructor 65 may measure the concentration, of the hygroscopic material W2, varying by the control of the concentration, and finish the control of the concentration (diluting or condensing the hygroscopic material W) in accordance with the result of the measurement.

The humidity control device 1 in the above configuration can stably absorb and desorb moisture.

Note that, in this embodiment, the separator 25 is, but not limited to, a cyclone separator. Alternatively, the separator 25 may be a mist separator in another configuration, such as an impactor.

Furthermore, in this embodiment, the control of the composition of the hygroscopic material W2 involves, but not limited to, adjusting the amount of water contained in the hygroscopic material W2.

For example, in response to the result of the measurement by the measurer 40, the control may involve adding polyalcohol to the hygroscopic material W2, so that the composition of the hygroscopic material W2 is within the region A in the FIG. 2. In such a case, the humidity control device 1 may be similar in configuration to the diluter 50 to add polyalcohol. Here, the polyalcohol to be added may be previously diluted with water so that the concentration of the diluted polyalcohol is lower than that of stock polyalcohol and higher than that of a target concentration of the polyalcohol in the hygroscopic material W2.

Moreover, an agitation mechanism may be provided to accelerate agitation of the polyalcohol and the hygroscopic material W2. Examples of the agitation mechanism include an agitation blade provided to the pipe 32 and positioned where the polyalcohol is added, and a static agitator provided inside the pipe 32. In addition, the pump 33 may be disposed downstream of the position, in the pipe 32, where the polyalcohol is added. Hence, the pump 33 may act as the agitating mechanism.

The humidity control device 1 of this embodiment ejects the air A2, which is dehumidified, from the moisture absorber 10 through the ejection passage 19. Moreover, the air A4 humidified is ejected from the atomizing separator 20 through the ejection passage 29. Using such mechanisms, the humidity control device 1 can adopt a configuration below.

If the humidity control device 1 of this embodiment can be used only for dehumidifying a space in which the humidity control device 1 is installed, the ejection passage 19 may, for example, have an air ejection port facing inside the room; whereas, the ejection passage 29 may, for example, have an air ejection port facing outside the room.

If the humidity control device 1 of this embodiment can be used only for humidifying a space in which the humidity control device 1 is installed, the ejection passage 29 may, for example, have an air ejection port facing inside the room; whereas, the ejection passage 19 may, for example, have an air ejection port facing outside the room.

If the humidity control device 1 of this embodiment can be used for both dehumidifying and humidifying a space in which the humidity control device 1 is installed, the air ejection ports of both of the ejection passages 19 and 29 may face inside the room, and the controller 60 may cause the air to be ejected from either air ejection port.

In the humidity control device 1 of this embodiment, the moisture absorber 10 and the atomizing separator 20 are housed in, but not limited to, the interior space 100c of the same casing 100. For example, the moisture absorber 10 and the atomizing separator 20 may separately be housed in individual casings as long as the moisture absorber 10 and the atomizing separator 20 are connected together with the circulator 30.

Described above is a preferable embodiment of the present invention, with reference to the drawings. As a matter of course, the present invention shall not be limited to the embodiment. The shapes and combinations of the constituent features described in the above embodiment are examples, and can be modified in various manners in accordance with, for example, a design requirement unless otherwise departing from the technical scope of the present invention.

### INDUSTRIAL APPLICABILITY

The present invention is applicable to an air conditioner to be used for conditioning indoor air.

1. A humidity control device, comprising:
a moisture absorber configured to cause a hygroscopic material to come into contact with air so that the hygroscopic material absorbs portion of moisture contained in the air, the hygroscopic material being in liquid and containing water, polyalcohol having hygroscopicity, and metal salt having hygroscopicity; and
a composition controller configured to control composition of the hygroscopic material,
the composition controller controlling the composition of the hygroscopic material to be within a range in which the hygroscopic material is capable of absorbing the moisture while the metal salt is kept from being deposited.

2. The humidity control device according to claim 1, wherein
the composition controller includes:
a measurer configured to measure a concentration of the hygroscopic material;
an adjuster configured to adjust the concentration of the hygroscopic material; and
a controller configured to control an operation of the adjuster in accordance with a result of the measurement by the measurer.

3. The humidity control device according to claim 2, wherein
the adjuster includes an atomizing separator configured to separate, from the hygroscopic material, portion of moisture contained in the hygroscopic material, the portion of the water being separated in a form of atomized droplets.

4. The humidity control device according to claim 3, wherein
the atomizing separator includes an ejection outlet configured to eject a mixture, containing the atomized droplets, out of the atomizing separator,
the atomized droplets include large droplets, and fine droplets smaller in diameter than the large droplets, and
the ejection outlet is provided with a separator configured to separate the large droplets from the mixture.

5. The humidity control device according to claim 4, wherein
the separator is a cyclone separator.

6. The humidity control device according to claim 2, wherein
the adjuster includes a diluter configured to add water to the hygroscopic material.

7. The humidity control device according to claim 1, wherein
the polyalcohol includes glycerin.

8. The humidity control device according to claim 1, wherein
the polyalcohol includes diglycerin.

9. The humidity control device according to claim 1, wherein
the polyalcohol includes polyglycerin.

10. The humidity control device according to claim 1, wherein
the metal salt includes lithium chloride.

11. The humidity control device according to claim 1, wherein
the metal salt includes calcium chloride.
